(19) United States
(12) Patent Application Publication
(10) Pub. No.: US 2024/0047828 A1
(43) Pub. Date: Feb. 8, 2024

(54) NON-AQUEOUS ELECTROLYTE SECONDARY BATTERY

(71) Applicant: MURATA MANUFACTURING CO., LTD., Kyoto (JP)

(72) Inventors: Kazuya MAYUMI, Kyoto (JP); Masumi FUKUDA, Kyoto (JP); Atsushi NEMOTO, Kyoto (JP)

(21) Appl. No.: 18/379,968

(22) Filed: Oct. 13, 2023

Related U.S. Application Data
(63) Continuation of application No. PCT/JP2022/009444, filed on Mar. 4, 2022.

(30) Foreign Application Priority Data
Apr. 23, 2021 (JP) 2021-073643

(51) Int. Cl. H01M 50/46; H01M 10/0525; H01M 10/0585; H01M 50/463; H01M 50/457; H01M 50/426; H01M 10/0569

(52) U.S. Cl. CPC H01M 50/46; H01M 10/0525; H01M 10/0585; H01M 50/463; H01M 50/457; H01M 50/426; H01M 10/0569; H01M 2300/004

(57) ABSTRACT

A non-aqueous electrolyte secondary battery is provided and includes an electrode body and a non-aqueous electrolytic solution. The electrode body includes a plurality of positive electrodes, a plurality of negative electrodes, and a plurality of separators, and the positive electrodes and the negative electrodes are stacked such that the separators are sandwiched therebetween, and such that the separators are protruded from peripheral edges of the positive electrodes and negative electrodes. Peripheral edges of the separators adjacent to each other with the positive electrode interposed therebetween have contact with each other, and peripheral edges of the separators adjacent to each other with the negative electrode interposed therebetween have contact with each other. The separator includes a substrate, a first surface layer provided on a first surface of the substrate, and a second surface layer provided on a second surface of the substrate. The first surface layer and the second surface layer include a polymer including a vinylidene fluoride unit and a hexafluoropropylene unit. The ratio by mass of the amount of the hexafluoropropylene unit to the total amount of the amount of the vinylidene fluoride unit and the amount of the hexafluoropropylene unit is 4.2% or more and 5.8% or less. The non-aqueous electrolytic solution contains a cyclic carbonate ester and a chain ester, and the ratio by mass of the cyclic carbonate ester to the chain ester is 0.2 or more and 0.7 or less.

### CROSS REFERENCE TO RELATED APPLICATIONS

The present application is a continuation of PCT patent application no. PCT/JP2022/009444, filed on Mar. 4, 2022, which claims priority to Japanese patent application no. 2021-073643, filed on Apr. 23, 2021, the entire contents of which are incorporated herein by reference.

### BACKGROUND

The present application relates to a non-aqueous electrolyte secondary battery.

In recent years, techniques for improving the safety of non-aqueous electrolyte secondary batteries have been studied. A technique is disclosed of improving safety by applying heat and pressure to edges of adjacent separation films to form a sealing part in an electrode assembly in which electrodes and separation films are alternately arranged.

### SUMMARY

The present application relates to a non-aqueous electrolyte secondary battery.

The technique described in the Background section has, however, the problem of decreasing the property of impregnating the electrode assembly with an electric solution due to the formation of the sealing part, thereby increasing the aging time. In addition, while the improved discharge characteristics of non-aqueous electrolyte secondary batteries have been desired in recent years, but technique described in the Background section fails to provide any technique for improving the discharge characteristics of the non-aqueous electrolyte secondary battery.

The present application relates to providing, in an embodiment, a non-aqueous electrolyte secondary battery capable of improving safety and discharge characteristics while keeping the impregnation property of an electrolytic solution from being decreased.

For solving the above problem mentioned above, the present application, in an embodiment, provides:
a non-aqueous electrolyte secondary battery including an electrode body and a non-aqueous electrolytic solution,
where the electrode body includes a plurality of positive electrodes, a plurality of negative electrodes, and a plurality of separators, and the positive electrodes and the negative electrodes are stacked such that the separators are sandwiched therebetween, and such that the separators are protruded from peripheral edges of the positive electrodes and of the negative electrode,
peripheral edges of the separators adjacent to each other with the positive electrode interposed therebetween have contact with each other, and peripheral edges of the separators adjacent to each other with the negative electrode interposed therebetween have contact with each other,
the separator includes a substrate, a first surface layer provided on a first surface of the substrate, and a second surface layer provided on a second surface of the substrate,
the first surface layer and the second surface layer include a polymer including a vinylidene fluoride unit and a hexafluoropropylene unit,
the ratio by mass of the amount of the hexafluoropropylene unit to the total amount of the amount of the vinylidene fluoride unit and the amount of the hexafluoropropylene unit is 4.2% or more and 5.8% or less, and
the non-aqueous electrolytic solution contains a cyclic carbonate ester and a chain ester, and the ratio by mass of the cyclic carbonate ester to the chain ester is 0.2 or more and 0.7 or less.

According to an embodiment of the present application, the safety and discharge characteristics can be improved while keeping the impregnation property of the electrolytic solution from being decreased.

### BRIEF DESCRIPTION OF THE FIGURES

FIG. 1 is an exploded perspective view illustrating an example of the configuration of a non-aqueous electrolyte secondary battery according to an embodiment of the present application.

FIG. 2 is a sectional view taken along a line II-II in FIG. 1.

FIG. 3 is an enlarged sectional view illustrating a part of FIG. 2.

FIG. 4 is a sectional view illustrating an example of the configuration of a separator.

FIG. 5 is a block diagram illustrating an example of the configuration of an electronic device according to another embodiment of the present application.

### DETAILED DESCRIPTION

One or more embodiments of the present application will be described below in further detail.

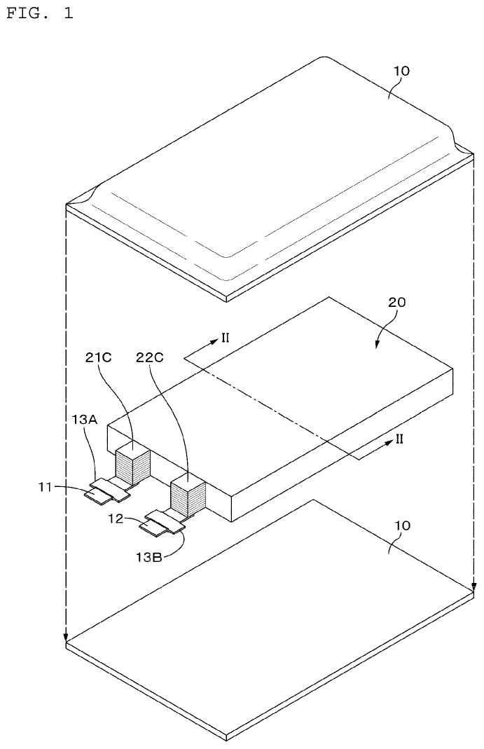

FIG. 1 shows an example of the configuration of a non-aqueous electrolyte secondary battery (hereinafter, referred to simply as “battery”) according to the first battery example of an embodiment. The battery is a so-called laminate-type battery, and includes an electrode body 20 and an exterior material 10.

The electrode body 20 has a positive electrode lead 11 and a negative electrode lead 12 attached thereto. The positive electrode lead 11 and the negative electrode lead 12 are each led out from the inside of the exterior material 10 toward the outside, for example, in the same direction. Each of the positive electrode lead 11 and the negative electrode lead 12 is made of, for example, a metal material such as Al, Cu, Ni, or stainless steel, and has a thin plate shape or a mesh shape.

The exterior material 10 is intended to house the electrode body 20. The exterior material 10 has the form of a film. The exterior material 10 is composed of, for example, a rectangular aluminum laminate film obtained by bonding a nylon film, an aluminum foil, and a polyethylene film in this order. For example, the exterior material 10 is disposed such that the polyethylene film side and the electrode body 20 face each other, and respective outer edges thereof are brought in close contact with each other by fusion or an adhesive. A close contact film 13A is inserted between the exterior material 10 and the positive electrode lead 11, and a close contact film 13B is inserted between the exterior material 10 and the negative electrode lead 12. The close contact film 13A and the close contact film 13B are intended to suppress ingress of outside air. The close contact film 13A and the close contact film 13B are made of a material that has adhesion respectively to the positive electrode lead 11 and the negative electrode lead 12, for example, a polyolefin resin such as a polyethylene, a polypropylene, a modified polyethylene, or a modified polypropylene.

It is to be noted that the exterior material 10 may be composed of a laminate film that has another structure, a polymer film such as a polypropylene, or a metal film, instead of the aluminum laminate film mentioned above. Alternatively, the exterior material 10 may be composed of a laminate film that has a polymer film laminated on one or both surfaces of an aluminum film as a core material.

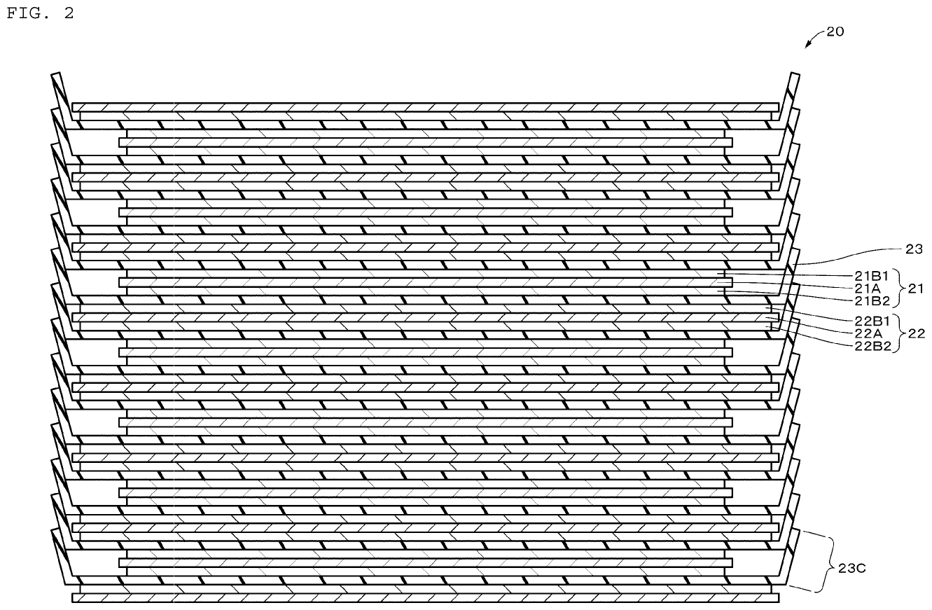

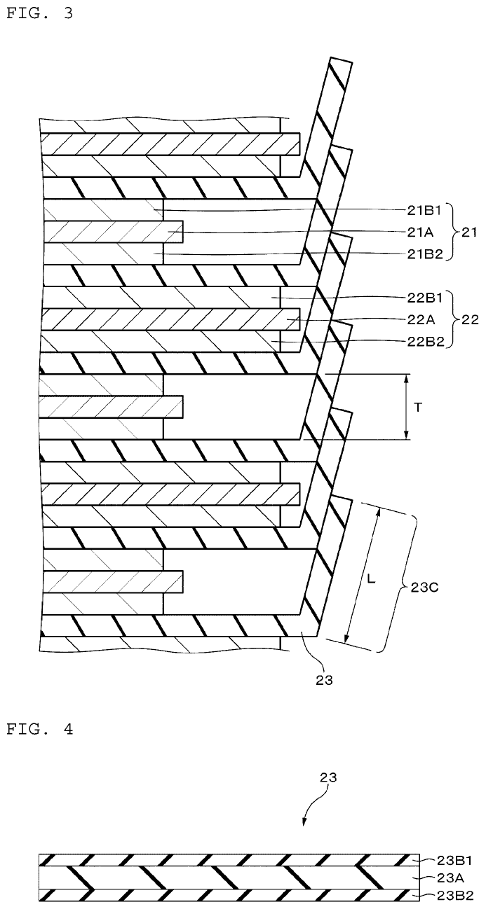

FIG. 2 is a sectional view of the electrode body 20 illustrated in FIG. 1, taken along a line II-II. FIG. 3 is an enlarged sectional view illustrating a part of FIG. 2. The electrode body 20 includes a plurality of positive electrodes 21, a plurality of negative electrodes 22, a plurality of separators 23, and an electrolytic solution as an electrolyte. The electrode body 20 has a stacked structure, and the positive electrodes 21 and the negative electrodes 22 are alternately stacked such that the separators 23 are sandwiched therebetween, and such that the separator 23 are protruded from peripheral edges of the positive electrodes 21 and negative electrodes 22. The positive electrodes 21, the negative electrodes 22, and the separators 23 are impregnated with the electrolytic solution.

While a configuration in which the electrode body 20 includes a plurality of separators 23 with the separators 23 disposed between the positive electrodes 21 and the negative electrodes 22 will be described herein, the configuration of the electrode body 20 is not limited to thereto, and the electrode body 20 may have, for example, a configuration in which the electrode body 20 includes one sheet of zigzag-folded separator 23, with the positive electrodes 21 and the negative electrodes 22 alternately disposed between the folded separators 23.

Hereinafter, the positive electrode 21, negative electrode 22, the separator 23, and electrolytic solution constituting the battery will be sequentially described.

The positive electrode 21 includes a positive electrode current collector 21A, a positive electrode active material layer 21B1 provided on a first surface of the positive electrode current collector 21A, and a positive electrode active material layer 21B2 provided on a second surface of the positive electrode current collector 21A. The positive electrode 21 has the form of a rectangular plate. One short side of the positive electrode 21 is provided with a terminal part 21C. The terminal part 21C is protruded from one short side of the positive electrode current collector 21A, and is formed integrally with the positive electrode current collector 21A. The terminal part 21C is, with the surface of exposed, not provided with the positive electrode active material layer 21B1 or the positive electrode active material layer 21B2. With the positive electrodes 21 and the negative electrodes 22 alternately stacked in a manner that sandwiches the separators 23 therebetween, the plurality of terminal parts 21C are joined to each other, and the positive electrode lead 11 is electrically connected to the joined terminal parts 21C. It is to be noted that in the present specification, the positive electrode 21 means the rectangular plate-shaped part excluding the terminal part 21C.

The positive electrode current collector 21A is made of, for example, a metal foil such as an aluminum foil, a nickel foil, or a stainless-steel foil. The positive electrode current collector 21A may have a plate shape or a mesh shape.

The positive electrode active material layer 21B1 and the positive electrode active material layer 21B2 include a positive electrode active material and a binder. The positive electrode active material layer 21B1 and the positive electrode active material layer 21B2 may further include a conductive aid.

The positive electrode active material is capable of occluding and releasing lithium. As the positive electrode active material, for example, a lithium-containing compound such as a lithium oxide, a lithium phosphorus oxide, a lithium sulfide, or an intercalation compound containing lithium is suitable, and two or more thereof may be used in mixture. For increasing the energy density, a lithium-containing compound containing lithium, a transition metal element, and oxygen is preferred. Examples of such a lithium-containing compound include a lithium composite oxide that has a layered rock-salt structure represented by the formula (A), and a lithium composite phosphate that has an olivine structure represented by the formula (B). The lithium-containing compound more preferably contains, as a transition metal element, at least one selected from the group consisting of Co, Ni, Mn, and Fe. Examples of such a lithium-containing compound include: a lithium composite oxide that has a layered rock-salt structure represented by the formula (C), the formula (D), or the formula (E); a lithium composite oxide that has a spinel structure represented by the formula (F); and a lithium composite phosphate that has an olivine structure represented by the formula (G), and specifically include LiNi_{0.50}Co_{0.20}Mn_{0.30}O₂, LiCoO₂, LiNiO₂, LiNiₐCo₁₋ₐO₂ (0<a<1), LiMn₂O₄, and LiFePO₄.

LiₚNi_{(1-q-r)}Mn_{q}M1ᵣO_{(2-y)}X_{z} (A)

(In the formula (A), M1 represents at least one of elements selected from Groups 2 to 15, excluding Ni and Mn. X represents at least one selected from the group consisting of Group 16 elements excluding oxygen and Group 17 elements. p, q, r, y, and z are values within the ranges of 0≤p≤1.5, 0≤q≤1.0, 0≤r≤1.0, −0.10≤y≤0.20, and 0≤z≤0.2.)

LiₐM2_{b}PO₄ (B)

(In the formula (B), M2 represents at least one of elements selected from Group 2 to Group 15. a and b are values within the ranges of 0≤a≤2.0 and 0.5≤b≤2.0.)

Li_{f}Mn_{(1-g-h)}Ni_{g}M3ₕO₍₂₋ⱼ₎Fₖ (C)

(In the formula (C), M3 represents at least one selected from the group consisting of Co, Mg, Al, B, Ti, V, Cr, Fe, Cu, Zn, Zr, Mo, Sn, Ca, Sr, and W. f, g, h, j, and k are values within the ranges of 0.8≤f≤1.2, 0≤g≤0.5, 0≤h≤0.5, g+h<1, −0.1≤j≤0.2, and 0≤k≤0.1. Further, the composition of lithium varies depending on the state of charge-discharge, and the value of f represents a value in a fully discharged state.)

LiₘNi₍₁₋ₙ₎M4ₙO₍₂₋ₚ₎Fq (D)

(In the formula (D), M4 represents at least one selected from the group consisting of Co, Mn, Mg, Al, B, Ti, V, Cr, Fe, Cu, Zn, Mo, Sn, Ca, Sr, and W. m, n, p, and q are values within the ranges of 0.8≤m≤1.2, 0.005≤n≤0.5, −0.1≤p≤0.2, and 0≤q≤0.1. Further, the composition of lithium varies depending on the state of charge-discharge, and the value of m represents a value in a fully discharged state.)

LiᵣCo₍₁₋ₛ₎M5ₛO₍₂₋ₜ₎Fᵤ (E)

(In the formula (E), M5 represents at least one selected from the group consisting of Ni, Mn, Mg, Al, B, Ti, V, Cr, Fe, Cu, Zn, Mo, Sn, Ca, Sr, and W. r, s, t, and u are values within the ranges of 0.8≤r≤1.2, 0≤s<0.5, −0.1≤t≤0.2, and 0≤u≤0.1. Further, the composition of lithium varies depending on the state of charge-discharge, and the value of r represents a value in a fully discharged state.)

LiᵥMn_{2-w}M6_{w}OₓF_{y} (F)

(In the formula (F), M6 represents at least one selected from the group consisting of Co, Ni, Mg, Al, B, Ti, V, Cr, Fe, Cu, Zn, Mo, Sn, Ca, Sr, and W. v, w, x, and y are values within the ranges of 0.9≤v≤1.1, 0≤w≤0.6, 3.7≤x≤4.1, and 0≤y≤0.1. Further, the composition of lithium varies depending on the state of charge-discharge, and the value of v represents a value in a fully discharged state.)

Li_{z}M7PO₄ (G)

(In the formula (G), M7 represents at least one selected from the group consisting of Co, Mg, Fe, Ni, Mg, Al, B, Ti, V, Nb, Cu, Zn, Mo, Ca, Sr, W, and Zr. z is a value within the range of 0.9≤z≤1.1. Further, the composition of lithium varies depending on the state of charge-discharge, and the value of z represents a value in a fully discharged state.)

In addition to these compounds, inorganic compounds containing no lithium, such as MnO₂, V₂O₅, V₆O₁₃, NiS, and MoS, can also be used as the positive electrode active material capable of occluding and releasing lithium.

The positive electrode active material capable of occluding and releasing lithium may be other than those mentioned above. In addition, two or more of the positive electrode active materials exemplified above may be mixed in any combination.

As a binder, for example, at least one selected from the group consisting of resin materials such as a polyvinylidene fluoride, a polytetrafluoroethylene, a polyacrylonitrile, a styrene-butadiene rubber, and a carboxymethyl cellulose, copolymers mainly containing these resin materials, and the like is used.

For example, at least one carbon material selected from the group consisting of graphite, carbon fibers, carbon black, acetylene black, Ketjen black, carbon nanotubes, graphene, and the like can be used as the conductive aid. It is to be noted that the conductive aid may be any material with conductivity, and is not to be considered limited to any carbon material. For example, a metal material or a conductive polymer material may be used as the conductive aid. In addition, examples of the shape of the conductive aid include, but not particularly limited to, a granular shape, a scaly shape, a hollow shape, a needle shape, or a cylindrical shape.

The negative electrode 22 includes a negative electrode current collector 22A, a negative electrode active material layer 22B1 provided on a first surface of the negative electrode current collector 22A, and a negative electrode active material layer 22B2 provided on a second surface of the negative electrode current collector 22A. The negative electrode 22 has the form of a rectangular plate. The size of the negative electrode 22 is larger than the size of the positive electrode 21, and with the positive electrode 21 and the negative electrode 22 alternately stacked in a manner that sandwiches the separators 23 therebetween, peripheral edges of the negative electrodes 22 are located outside peripheral edges of the positive electrodes 21. One short side of the negative electrode 22 is provided with a terminal part 22C. The terminal part 22C is protruded from one short side of the negative electrode current collector 22A, and is formed integrally with the negative electrode current collector 22A. The terminal part 22C is, with the surface of exposed, not provided with the negative electrode active material layer 22B1 or the negative electrode active material layer 22B2. With the positive electrodes 21 and the negative electrodes 22 stacked with the separators 23 sandwiched therebetween, the plurality of terminal parts 22C are joined to each other, and the negative electrode lead 12 is electrically connected to the joined terminal parts 22C.

It is to be noted that in the present specification, the negative electrode 22 means the rectangular plate-shaped part excluding the terminal part 22C.

The negative electrode current collector 22A is made of, for example, a metal foil such as a copper foil, a nickel foil, or a stainless-steel foil. The negative electrode current collector 22A may have a plate shape or a mesh shape.

The negative electrode active material layer 22B1 and the negative electrode active material layer 22B2 include a negative electrode active material and a binder. The negative electrode active material layer 22B1 and the negative electrode active material layer 22B2 may further include at least one selected from the group consisting of a thickener or a conductive aid, if necessary.

The negative electrode active material is capable of occluding and releasing lithium. Examples of the negative electrode active material include carbon materials such as non-graphitizable carbon, graphitizable carbon, graphite, pyrolytic carbons, cokes, glassy carbons, fired products of organic polymer compounds, carbon fibers, and activated carbon. Among these materials, examples of the cokes include pitch coke, needle coke, and petroleum coke. The fired product of an organic polymer compound refers to a carbonized product obtained by firing a polymer material such as a phenol resin or a furan resin at an appropriate temperature, and some fired products of organic polymer compounds are classified as non-graphitizable carbon or graphitizable carbon. These carbon materials are preferred, because the crystal structures are very unlikely to be changed in the case of charge-discharge, thereby allowing a high charge-discharge capacity to be obtained as well as favorable cycle characteristics. In particular, graphite is preferred, because of its large electrochemical equivalent, which allows the achievement of a high energy density. In addition, non-graphitizable carbon is preferred, because excellent cycle characteristics are achieved. Furthermore, materials that are low in charge-discharge potential, specifically materials that are close in charge-discharge potential to lithium metal are preferred, because the increased energy density of the battery can be easily achieved.

In addition, examples of other negative electrode active materials capable of increasing the capacity include materials containing, as a constituent element (for example, an alloy, a compound, or a mixture), at least one selected from the group consisting of metal elements and metalloid elements. This is because the use of such a material can achieve a high energy density. In particular, the use of such a material in combination with a carbon material is more preferred, because a high energy density can be obtained as well as excellent cycle characteristics. It is to be noted that in the present invention, the alloy encompasses an alloy containing one or more metal elements and one or more metalloid elements, in addition to an alloy composed of two or more metal elements. In addition, the alloy may contain a nonmetallic element. The structure encompasses a solid solution, a eutectic (eutectic mixture), an intermetallic compound, or two or more thereof in coexistence.

Examples of such a negative electrode active material include a metal element or metalloid element capable of forming an alloy with lithium. Specific examples thereof include Mg, B, Al, Ti, Ga, In, Si, Ge, Sn, Pb, Bi, Cd, Ag, Zn, Hf, Zr, Y, Pd, and Pt. These elements may be crystalline or amorphous.

The negative electrode active material preferably contains a metal element or metalloid element of Group 4B in the short periodic table as a constituent element, more preferably contains at least either of Si or Sn as a constituent element. This is because Si and Sn are high in ability of occluding and releasing lithium to allow the achievement of a high energy density. Examples of such a negative electrode active material include: a simple substance of Si, an alloy thereof, or a compound thereof; a simple substance of Sn, an alloy thereof, or a compound thereof; and a material containing one, or two or more thereof in at least a part of the material.

Examples of the alloy of Si include alloys containing, as a second constituent element other than Si, at least one selected from the group consisting of Sn, Ni, Cu, Fe, Co, Mn, Zn, In, Ag, Ti, Ge, Bi, Sb, Nb, Mo, Al, P, Ga, and Cr. Examples of the alloy of Sn include alloys containing, as a second constituent element other than Sn, at least one selected from the group consisting of Si, Ni, Cu, Fe, Co, Mn, Zn, In, Ag, Ti, Ge, Bi, Sb, Nb, Mo, Al, P, Ga, and Cr.

Examples of the compound of Sn or the compound of Si include compounds containing O or C as constituent elements. These compounds may contain the second constituent element mentioned above.

Particularly, the Sn-based negative electrode active material preferably contains Co, Sn, and C as constituent elements, and has a less crystalline or an amorphous structure.

Examples of other negative electrode active materials include metal oxides or polymer compounds capable of occluding and releasing lithium. Examples of the metal oxides include a lithium titanium oxide containing Li and Ti, such as lithium titanate (Li₄Ti₅O₁₂), an iron oxide, a ruthenium oxide, and a molybdenum oxide. Examples of the polymer compound include a polyacetylene, a polyaniline, and a polypyrrole.

The same binders as those for the positive electrode active material layer 21B1 and the positive electrode active material layer 21B2 can be exemplified as the binder.

The same conductive aids as those for the positive electrode active material layer 21B1 and the positive electrode active material layer 21B2 can be exemplified as the conductive aid.

The separator 23 is intended to separate the positive electrode 21 and the negative electrode 22 from each other, thereby preventing a short circuit due to contact between the both electrodes, and at the same time, allowing lithium to pass through the separator 23. The separator 23 has the form of a rectangular film. The size of the separator 23 is larger than the sizes of the positive electrode 21 and negative electrode 22. Peripheral edges of the separators 23 adjacent to each other with the positive electrode 21 interposed therebetween have contact with each other, and peripheral edges of the separators 23 adjacent to each other with the negative electrode 22 interposed therebetween have contact with each other. More specifically, the separator 23 has an excess part (peripheral edge) 23C protruded from the peripheral edge located on the outer side, of the peripheral edges of the positive electrode 21 and negative electrode 22. The excess parts 23C of the separators 23 adjacent to each other with the positive electrode 21 interposed therebetween have contact with each other, and the excess parts 23C of the separators 23 adjacent to each other with the negative electrode 22 interposed therebetween have contact with each other. The excess parts 23C of the adjacent separators 23 have contact with each other as described above, thereby allowing the excess parts 23C of the adjacent separators 23 to adhere to each other when the temperature of the battery is increased due to heating or the like. In the present specification, the peripheral edge of the separator 23 refers to a region that has a predetermined width from the peripheral edge of the separator 23 toward the inside.

The excess parts 23C of the plurality of separators 23 are preferably bent in the same stacking direction of the electrode body 20. The excess parts 23C of the plurality of separators 23 are bent in the same stacking direction of the electrode body 20, thereby allowing the external dimensions of the battery can be reduced. The excess part 23C may be bent in a curved or flexed form.

While an example in which the peripheral edge of the negative electrode 22 is located outside the peripheral edge of the positive electrode 21 will be described in the present embodiment, the peripheral edge of the positive electrode 21 may be located outside the peripheral edge of the negative electrode 22, or the peripheral edge of the positive electrode 21 and the peripheral edge of the negative electrode 22 may coincide with each other in position. When the peripheral edge of the positive electrode 21 and the peripheral edge of the negative electrode 22 coincide with each other in position, the peripheral edge located on the outer side, of the positive electrode 21 and the negative electrode 22, means the peripheral edge of the positive electrode 21 or negative electrode 22.

The lower limit of the ratio (L/T) of the length L of the excess part 23C to the thickness T of the thicker electrode of the positive electrode 21 and negative electrode 22 is preferably more than 1, more preferably 4 or more, still more preferably 8 or more. When the ratio (L/T) exceeds 1, the adjacent excess parts 23C can be brought into contact with each other in a case where the excess parts 23C of the plurality of separators 23 are bent in the same stacking direction of the electrode body 20. Accordingly, in a case where the temperature of the battery is increased due to heating or the like, the excess parts 23C of the separators 23 are allowed to adhere to each other. When the ratio (L/T) is 4 or more, the adhesion area between the adjacent excess parts 23C is increased, thus allowing the safety to be further improved. The upper limit of the ratio (L/T) is preferably 25 or less. When the ratio (L/T) is 25 or less, the exterior material 10 can be prevented from being caught in a sealing part.

The length L of the excess part 23C means the amount of protrusion of the separator 23 from the peripheral edge located on the outer side, of the peripheral edges of the positive electrode 21 and negative electrode 22.

Specifically, the length L means a protruded length of the separator 23 in a direction perpendicular to the peripheral edge located on the outer side as a reference, of the peripheral edges of the positive electrode 21 and negative electrode 22. It is to be noted that in a case where the positive electrode 21 and the negative electrode 22 have the same thickness, the thickness T of the thicker electrode of the positive electrode 21 and negative electrode 22 means the thickness of the positive electrode 21 or negative electrode 22.

The ratio (L/T) is determined as follows. First, the thickness T1 of the positive electrode 21 with the battery discharged to 3.0 V is measured. Next, the thickness T2 of the negative electrode 22 with the battery fully charged is measured. Next, of the thickness T1 of the positive electrode 21 and the thickness T2 of the negative electrode 22, the larger electrode thickness is defined as the thickness T of the electrode. Next, the length L of the excess part 23C of the separator 23 is measured. Next, the ratio (L/T) is calculated with the use of the thickness T of the electrode and the length L of the excess part 23C.

It is to be noted that in a case where the length L of the excess part 23C differs depending on each side of the negative electrode 22, the ratio (L/T) is determined with the use of the length L of the shortest excess part 23C among the lengths L of the excess parts 23C. In addition, in a case where the length L of the excess part 23C varies depending on the position on the peripheral edge of the negative electrode 22, the ratio (L/T) is determined with the use of the length L of the shortest excess part 23C on the peripheral edge of the negative electrode 22.

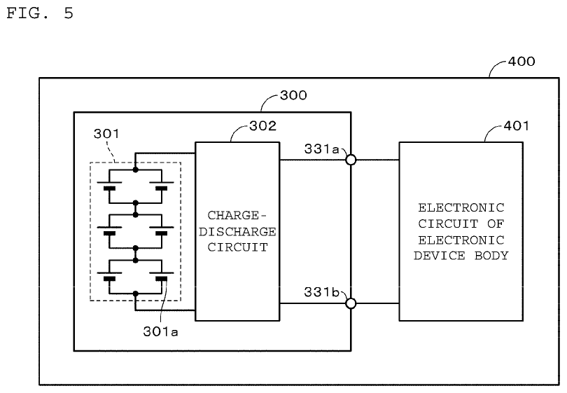

FIG. 4 is a sectional view illustrating an example of the configuration of the separator 23. The separator 23 includes a substrate 23A, a surface layer 23B1, and a surface layer 23B2.

The substrate 23A is a porous film composed of an insulating film that transmits lithium ions and has predetermined mechanical strength. The substrate 23A may have a structure that has two or more porous films laminated. The electrolytic solution is held in open pores of the substrate 23A. For this reason, the substrate 23A preferably has characteristics of being high in resistance to the electrolytic solution, low in reactivity, and less likely to expand.

The porous film is made of a resin material. For example, a polytetrafluoroethylene, a polyolefin resin (for example, a polypropylene (PP) or a polyethylene (PE)), an acrylic resin, a styrene resin, a polyester resin, a nylon resin, or a resin obtained by blending two or more of these resins is used as the resin material consisting the porous film.

Above all, a porous membrane made of a polyolefin is preferred, because of having an excellent effect of preventing short circuits and allowing the safety of the battery to be improved by the shutdown effect. In particular, polyethylene is capable of achieving a shutdown effect within the range of 100° C. or higher and 160° C. or lower and also excellent in electrochemical stability, and are thus preferred as a material constituting the substrate 23A. Above all, a low-density polyethylene, a high-density polyethylene, and a linear polyethylene are suitably used, because of having appropriate melting temperatures and being easily available. In addition, a material obtained by copolymerizing or blending a resin with chemical stability with a polyethylene or a polypropylene can be used. Alternatively, the porous film may have a structure of three or more layers: a polypropylene layer, a polyethylene layer, and a polypropylene layer sequentially laminated. Desirably, the porous film has a three-layer structure of PP/PE/PP, and the ratio by mass [mass %] between PP and PE is adjusted to be PP:PE=60:40 to 75:25. Alternatively, a single-layer substrate of 100% by mass PP or 100% by mass PE can also be employed from the viewpoint of cost. The method for fabricating the substrate 23A may be a wet method or a dry method.

The substrate 23A may be made of a nonwoven fabric. As fibers constituting the nonwoven fabric, aramid fibers, glass fibers, polyolefin fibers, polyethylene terephthalate (PET) fibers, nylon fibers, and the like can be used. In addition, two or more of these fibers may be mixed for the nonwoven fabric.

The surface layer 23B1 is provided on the first surface of the substrate 23A. The surface layer 23B1 faces the positive electrode 21. The surface layer 23B2 is provided on the second surface of the substrate 23A. The surface layer 23B2 faces the negative electrode 22. The surface layer 23B1 and the surface layer 23B2 are provided respectively on the first surface and second surface of the substrate 23A, thereby allowing the oxidation resistance, heat resistance, and mechanical strength of the separator 23 to be enhanced.

The surface layer 23B1 and the surface layer 23B2 include inorganic particles and a resin material. The inorganic particles have electrical insulation properties. In addition, the inorganic particles have oxidation resistance and heat resistance. The surface layer 23B1 facing the positive electrode 21 includes the inorganic particles, thereby allowing strong resistance to be imparted to the separator 23, against an oxidizing environment in the vicinity of the positive electrode 21 at the time of charging.

The inorganic particles contain at least one selected from the group consisting of, for example, a metal oxide, a metal nitride, a metal carbide, and a metal sulfide. The metal oxide contains at least one selected from the group consisting of, for example, an aluminum oxide (alumina, Al₂O₃), boehmite (hydrated aluminum oxide), a magnesium oxide (magnesia, MgO), a titanium oxide (titania, TiO₂), a zirconium oxide (zirconia, ZrO₂), a silicon oxide (silica, SiO₂), and an yttrium oxide (yttria, Y₂O₃). The metal nitride contains at least one selected from the group consisting of, for example, a silicon nitride (Si₃N₄), an aluminum nitride (AlN), a boron nitride (BN), and a titanium nitride (TiN). The metal carbide contains at least one selected from the group consisting of, for example, a silicon carbide (SiC) and a boron carbide (B₄C). The metal sulfide contains, for example, a barium sulfate (BaSO₄). Among the metal oxides mentioned above, at least one selected from the group consisting of alumina, titania (particularly, that has a rutile structure), silica, and magnesia is preferred, and alumina is more preferred.

The inorganic particles may contain at least one selected from the group consisting of a porous aluminosilicate such as zeolite (M_{2/n}O·Al₂O₃·xSiO₂·yH₂O, M is a metal element, x≥2, y≥0), a layered silicate, a barium titanate (BaTiO₃), a strontium titanate (SrTiO₃), and the like.

The shapes of the inorganic particles are not to be considered particularly limited, and may be any of spherical, plate, fibrous, cubic, and random shapes.

Inorganic particles that have one type of shape may be used, or inorganic particles that have two or more types of shapes may be used in combination.

The average particle size of the inorganic particles preferably has an upper limit of 10 μm or less. When the average particle size of the inorganic particles is 10 μm or less, the distance between the positive electrode 21 and the negative electrode 22 is reduced, the active material filling amount can be sufficiently obtained in a limited space, and thus, a decrease in battery capacity is suppressed. The average particle size of the inorganic particles preferably has a lower limit of 1 nm or more. When the average particle size of the inorganic particles is less than 1 nm, it may be difficult to obtain the inorganic particles.

The substrate 23A may include the inorganic particles.

In addition, the surface layer 23B1 and the surface layer 23B2 may be made of only a resin material without including the inorganic particles.

The resin material included in the surface layer 23B1 and the surface layer 23B2 binds the inorganic particles to the surface of the substrate 23A and binds the inorganic particles to each other. The resin material may have a three-dimensional network structure that has, for example, a plurality of fibrils connected by fibrillation. The inorganic particles may be supported on the resin material that has the three-dimensional network structure. In addition, the resin material may bind the surface of the substrate 23A and bind the inorganic particles to each other without being fibrillated. In this case, higher binding properties can be obtained.

The resin material contains a copolymer including a vinylidene fluoride (VdF) unit and a hexafluoropropylene (HFP) unit. The copolymer may be a binary copolymer (VdF-HFP copolymer) composed of a vinylidene fluoride (VdF) unit and a hexafluoropropylene (HFP) unit, or may be a multi-component copolymer including another monomer unit. It is to be noted that in the present specification, the vinylidene fluoride unit means a constituent unit derived from a vinylidene fluoride, the hexafluoropropylene unit means a constituent unit derived from a hexafluoropropylene, and the other monomer unit means a constituent unit derived from another monomer.

The ratio by mass R1 (=(M2/M)×100) of the amount M2 of the hexafluoropropylene unit to the total amount M (=M1+M2) of the amount M1 of the vinylidene fluoride unit and the amount M2 of the hexafluoropropylene unit is preferably 4.2% or more and 5.8% or less. When the ratio by mass R1 is less than 4.2%, the swelling ratios of the surface layer 23B1 and surface layer 23B2 will be decreased. For this reason, when the temperature of the battery is increased due to heating or the like to cause the excess parts 23C of the separators 23 adhere to each other, the adhesion strength Ts between the excess parts 23C will be decreased.

Accordingly, due to the shrinkage of the separators 23, the adhering excess parts 23C are more likely to be peeled off from each other, thereby failing to improve the safety of the battery. In contrast, when the ratio by mass R1 exceeds 5.8%, the surface layer 23B1 and the surface layer 23B2 are excessively swollen, the pores of the surface layer 23B1 and surface layer 23B2 are blocked, and thus, the discharge characteristics are degraded.

The ratio by mass R1 (=(M2/M)×100) is determined as follows. First, the battery is disassembled, and the separator 23 is taken out. Next, the separator 23 is immersed in a dimethyl carbonate (DMC) by shaking for 60 minutes to remove the electrolytic solution included in the separator 23, and then the separator 23 is dried in a draft all day and night. Next, the surface layer 23B1 and surface layer 23B2 of the separator 23 are dissolved with the use of a solvent such as NMP to obtain an extraction solvent in which the surface layer 23B1 and the surface layer 23B2 are dissolved. Next, the extraction solvent is filtered to remove impurities (inorganic particles) included in the extraction solvent, and then, the filtrate is dried to obtain a solid sample (resin component). Next, the solid sample is measured by using gas chromatography mass spectrometry (GC-MS). The measurement apparatus and measurement conditions are as follows:
Apparatus: 5977 from Agilent technology
Colume: DB-WAX manufactured by Agilent technology (length: 30 m, diameter: 0.25 mm, film thickness: 0.50 μm)
Temperature condition: 40° C.
Inlet temperature: 210° C.
Carrier gas: He-gas (1 mL/min)
Mass spectrometry conditions: interface temperature 235° C., ion source 260° C., quadrupole part 150° C.

Next, the proportions of the amount M1 of vinylidene fluoride unit and the amount M2 of hexafluoropropylene unit are calculated from the mass spectrum obtained by the measurement, and the ratio by mass R1 is determined from the following formula.

Ratio by mass R1[%]=(M2/(M1+M2))×100

When the excess parts 23C adhere to each other after heating at the battery surface temperature of 85° C. for 10 minutes, the lower limit of the adhesion strength Ts between the excess parts 23C is preferably 4.00 mN/mm or more, more preferably 5.00 mN/mm or more, still more preferably 6.00 mN/mm or more. The adhesion strength Ts of 4.00 mN/mm allows the excess parts 23C to be kept from being peeled from each other, if the temperature of the battery reaches 85° C. or higher and thus shrinks the separators 23. Accordingly, the positive electrode 21 and the negative electrode 22 can be kept from being brought into contact with each other and short-circuited due to the shrinkage of the separator 23. Thus, the safety of the battery can be improved. When the excess parts 23C adhere to each other due to heating at the temperature of 85° C. for 10 minutes, the upper limit of the adhesion strength Ts between the excess parts 23C is not particularly limited, but is, for example, 40.0 mN/mm or less.

The adhesion strength Ts between the excess parts 23C is determined by the method described in an example described later.

The electrolytic solution, which is a so-called non-aqueous electrolytic solution, includes a non-aqueous solvent (organic solvent) and an electrolyte salt dissolved in the non-aqueous solvent. The electrolytic solution may include a known additive to improve battery characteristics. It is to be noted that the battery may include an electrolyte layer including an electrolytic solution and a polymer compound that serves as a holding body for holding this electrolytic solution, instead of the electrolytic solution. In this case, the electrolyte layer may have the form of a gel.

The non-aqueous solvent includes a cyclic carbonate ester and a chain ester. The cyclic carbonate ester preferably contains at least one selected from the group consisting of an ethylene carbonate (EC), a propylene carbonate (PC), and the like, and particularly preferably contains both the ethylene carbonate and the propylene carbonate.

The chain ester enters the gaps between molecular chains of the surface layer 23B1 and surface layer 23B2 of the separator 23, and swells the surface layer 23B1 and the surface layer 23B2. The chain ester contains at least one selected from the group consisting of, for example, a diethyl carbonate, a dimethyl carbonate, an ethyl methyl carbonate, a methyl propyl carbonate, a methyl acetate, an ethyl acetate, a propyl acetate, a methyl formate, an ethyl formate, a propyl formate, a methyl butyrate, a methyl propionate, an ethyl propionate, a propyl propionate, and the like.

The ratio by mass R2 (cyclic carbonate ester/chain ester) of the cyclic carbonate ester to the chain ester in the electrolytic solution is 0.2 or more and 0.7 or less. When the ratio by mass R2 is less than 0.2, the chain ester excessively enters the gaps between the molecular chains of the surface layer 23B1 and surface layer 23B2 of the separator 23, and the swelling ratios of the surface layer 23B1 and surface layer 23B2 are excessively increased. Thus, the surface layer 23B1 and the surface layer 23B2 are excessively swollen, and the pores of the surface layer 23B1 and the surface layer 23B2 are blocked. In addition, when the ratio by mass R2 is less than 0.2, the content of the chain ester in the electrolytic solution becomes excessive, and makes it difficult to dissociate the lithium salt, thus deteriorating the ionic conductivity of the electrolytic solution. Accordingly, the discharge characteristics of the battery are deteriorated. In contrast, when the ratio by mass R2 exceeds 0.7, the content of the chain ester in the electrolytic solution is low, thereby decreasing the swelling ratios of the surface layer 23B1 and surface layer 23B2 of the separator 23. Accordingly, when the temperature of the battery is increased due to heating or the like to cause the excess parts 23C of the separators 23 to adhere to each other, the adhesion strength Ts between the excess parts 23C is decreased. Accordingly, due to the shrinkage of the separators 23, the adhering excess parts 23C are more likely to be peeled off from each other, thereby failing to improve the safety of the battery.

The ratio by mass R2 (cyclic carbonate ester/chain ester) is determined as follows. First, the exterior material 10 is peeled off, and the electrode body 20 is taken out, and immersed in a solvent (DMC) for 24 hours to extract the electrolyte solution. Next, the extracted electrolytic solution is measured by gas chromatography mass spectrometry (GC-MS). The measurement apparatus and the measurement conditions are the same as those in the method for measuring the ratio by mass R1.

The proportions of the chain ester and cyclic carbonate ester are each calculated from the chromatogram obtained under the measurement conditions mentioned above, and the ratio by mass R2 of the cyclic carbonate ester to the chain ester (cyclic carbonate ester/chain ester) is determined.

Specifically, for example, when the electrolytic solution includes a propyl propionate as the chain ester, and an ethylene carbonate and a propylene carbonate as the cyclic carbonate ester, the ratio by mass R2 is determined as follows. More specifically, the proportions of the propyl propionate (retention time: 5.5 min) E, ethylene carbonate (retention time: 17.5 min) CE, and propylene carbonate (retention time: 16.3 min) CP are each calculated from the chromatogram obtained under the measurement conditions mentioned above, and the ratio by mass R2 is determined from the following formula.

Ratio by mass R2=(CE+CP)/(E)

The non-aqueous solvent may further contain at least one selected from the group consisting of 2,4-difluoroanisole, a vinylene carbonate, and the like. This is because the 2,4-difluoroanisole can further improve the discharge capacity, and because the vinylene carbonate can further improve cycle characteristics.

In addition to these, the non-aqueous solvent may further contain at least one selected from the group consisting of butylene carbonate, γ-butyrolactone, γ-valerolactone, 1,2-dimethoxyethane, tetrahydrofuran, 2-methyltetrahydrofuran, 1,3-dioxolane, 4-methyl-1,3-dioxolane, a methyl acetate, a methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, a dimethyl sulfoxide, a trimethyl phosphate, and the like.

As the electrolyte salt, for example, a lithium salt is used. Examples of the lithium salt include at least one selected from the group consisting of LiPF₆, LiBF₄, LiAsF₆, LiClO₄, LiB C₆H₅)₄, LiCH₃SO₃, LiCF₃SO₃, LiN(SO₂CF₃)₂, LiC(SO₂CF₃)₃, LiAlCl₄, LiSiF₆, LiCl, a lithium difluoro[oxolato-O,O′]borate, a lithium bisoxalate borate, LiBr, and the like. Among these salts, LiPF₆ is preferred because of allowing a high ion conductivity to be obtained and allowing cycle characteristics to be further improved.

Next, an example of a method for manufacturing the battery according to a first embodiment of the present application will be described below in further detail.

The positive electrode 21 is prepared as follows. First, for example, a positive electrode active material, a binder, and a conductive aid are mixed to prepare a positive electrode mixture, and this positive electrode mixture is dispersed in a solvent such as N-methyl-2-pyrrolidone (NMP) to prepare a paste-like positive electrode mixture slurry. Next, this positive electrode mixture slurry is applied to the first surface and second surface of the positive electrode current collector 21A, the solvent is dried, and compression molding is performed with a roll press machine or the like to form the positive electrode active material layer 21B1 and the positive electrode active material layer 21B2, thereby providing the positive electrode 21. Finally, the positive electrode 21 is cut (slit) into a predetermined shape to obtain the plurality of positive electrodes 21 provided with the terminal parts 21C.

The negative electrode 22 is prepared as follows. First, for example, a negative electrode active material and a binder are mixed to prepare a negative electrode mixture, and this negative electrode mixture is dispersed in a solvent such as N-methyl-2-pyrrolidone to prepare a paste-like negative electrode mixture slurry. Then, this negative electrode mixture slurry is applied to the first surface and second surface of the negative electrode current collector 22A, the solvent is dried, and compression molding is performed with a roll press machine or the like to form the negative electrode active material layer 22B1 and the negative electrode active material layer 22B2, thereby providing the negative electrode 22. Finally, the negative electrode 22 is cut (slit) into a predetermined shape to obtain the plurality of negative electrodes 22 provided with the terminal parts 22C.

The separator 23 is prepared as follows. First, for example, a slurry composed of a matrix resin, a solvent, and inorganic particles is applied to the first surface and second surface of the substrate 23A. Next, the surface layer 23B1 and the surface layer 23B2 are formed by drying after passing through a poor solvent for the matrix resin and a good solvent bath for the solvent for performing phase separation, thereby providing the separator 23. Finally, the separator 23 is cut (slit) into a predetermined shape to obtain the plurality of separators 23.

The stacked type electrode body 20 is fabricated as follows. First, the plurality of positive electrodes 21, the plurality of negative electrodes 22, and the plurality of separators 23 are stacked in the order of separator 23, negative electrode 22, separator 23, positive electrode 21, separator 23, . . . , separator 23, positive electrode 21, separator 23, negative electrode 22, separator 23 to prepare the stacked type electrode body 20. Next, the terminal parts 21C of the plurality of stacked positive electrodes 21 are joined to each other, and the positive electrode lead 11 is electrically connected to the joined terminal parts 21C. In addition, the terminal parts 22C of the plurality of stacked negative electrodes 22 are joined to each other, and the negative electrode lead 12 is electrically connected to the joined terminal parts 22C. Examples of the connection method include ultrasonic welding, resistance welding, and soldering, and in consideration of damage to the terminal parts 21C and the terminal parts 22C due to heat, it is preferable to use a method that less heat-affects the terminal parts, such as ultrasonic welding or resistance welding.

The electrode body 20 is sealed by the exterior material 10 as follows. First, the electrode body 20 is sandwiched by the exterior material 10, the outer peripheral edge excluding one side is subjected to thermal fusion bonding to form a bag shape, and the electrode body 20 is thus housed inside the exterior material 10. In this case, the close contact film 13A is inserted between the positive electrode lead 11 and the exterior material 10, and the close contact film 13B is inserted between the negative electrode lead 12 and the exterior material 10. It is to be noted that the close contact film 13A and the close contact film 13B may be attached in advance respectively to the positive electrode lead 11 and the negative electrode lead 12. In housing the electrode body 20 in the exterior material 10, the excess parts 23C of the plurality of separators 23 may be bent in the same stacking direction of the electrode body 20 with the use of the inner side surface of the exterior material 10. Next, the electrolytic solution is injected into the exterior material 10 from the side that is not fusion-bonded, and the side that is not fusion-bonded is then subjected to thermal fusion bonding for hermetical sealing in a vacuum atmosphere. As described above, the battery shown in FIG. 1 is obtained.

In the surface layer 23B1 and the surface layer 23B2, the ratio by mass R1 (=(M2/M)×100) of the amount M2 of the hexafluoropropylene unit to the total amount M (=M1+M2) of the amount M1 of the vinylidene fluoride unit and the amount M2 of the hexafluoropropylene unit is 4.2% or more and 5.8% or less, and in the electrolytic solution, the ratio by mass R2 (cyclic carbonate ester/chain ester) of the chain ester to the cyclic carbonate ester is 0.2 or more and 0.7 or less.

In the battery according to the first embodiment, the adjacent excess parts only have contact with each other in the battery manufacturing process, thus allowing the impregnation property of the electrolytic solution for the electrode body 20 to be kept from being decreased. Accordingly, the aging time can be kept from being increased, and the productivity of the battery can be thus kept from being decreased.

In addition, the surface layer 23B1 and the surface layer 23B2 are kept from being excessively swollen, thereby allowing the pores of the surface layer 23B1 and surface layer 23B2 to be kept from being blocked. Accordingly, the lithium ion permeability can be kept from being decreased. Thus, the load characteristic of the battery can be improved.

In the battery according to the first embodiment, the separators 23 have the excess parts 23C protruded from the peripheral edge located on the outer side, of the peripheral edges of the positive electrodes 21 and negative electrodes 22, and the adjacent excess parts 23C have contact with each other at normal temperature, without adhering to each other. When the temperature of the battery is increased due to heating or the like, the swelling ratio of the vinylidene fluoride copolymer included in the excess parts 23C of the separators 23 is increased. Accordingly, the anchor effect described later allows the excess parts 23C adjacent in contact with each other to adhere to each other.

Furthermore, the swelling ratios of the surface layer 23B1 and surface layer 23B2 are kept from being excessively decreased, thereby allowing the adhesion strength Ts between the excess parts 23C to be kept from being decreased. Accordingly, the adhering excess parts 23C can be kept from being peeled from each other due to shrinkage of the separators 23. Accordingly, the safety of the battery can be improved.

The swelling ratio generally refers to a weight swelling ratio that can be calculated from the weight before and the weight after immersing a certain test piece in a certain solvent for a predetermined period of time. When a common polymer material is immersed in an organic solvent, the weight swelling ratio has a tendency to be increased at an elevated temperature. In addition, the weight swelling ratio can be changed depending on the type of the polymer or copolymer constituting the polymer material or the combination thereof. Alternatively, the weight swelling ratio can also be changed by appropriately selecting the types or combination of organic solvents.

In the battery according to the first embodiment, the surface layer 23B1 and the surface layer 23B2 include a polymer including a vinylidene fluoride unit and a hexafluoropropylene unit. The weight swelling ratio has a tendency to be increased when the hexafluoropropylene unit is included in a larger amount.

In the battery according to the first embodiment, the ratio by mass R2 (cyclic carbonate ester/chain ester) of the chain ester to the cyclic carbonate ester is 0.2 or more and 0.7 or less in the electrolytic solution. When the solvent in the electrolytic solution contains the chain ester in a large amount, the chain ester is likely to enter the gaps between the molecular chains of the polymer, thus increasing the weight swelling ratio. In addition, also when the temperature of the battery is increased due to heating or the like, the weight swelling ratio of the polymer is increased.

When the resins included in the surface layer 23B1 and surface layer 23B2 of the adjacent excess parts 23C are each swollen by absorbing the solvent, the resins are gelled, and parts thereof are exposed to the surface.

In the battery according to the first embodiment, the surface layer 23B1 and surface layer 23B2 of the adjacent excess parts 23C have contact with each other. More specifically, parts of the gelled resins in the surface layer 23B1 and surface layer 23B2 have in contact with each other.

When the resins are low in swelling ratio, the resins fail to enter mutually the uneven surfaces of the surface layer 23B1 and surface layer 23B2 adjacent in contact with each other, and thus, the layers will not adhere to each other.

When the swelling ratios of the resins of the surface layer 23B1 and surface layer 23B2, however, exceed a predetermined level, the gelled resins can easily enter mutually the irregularities of the surface layer 23B1 and surface layer 23B2 adjacent in contact with each other. As a result, the surface layer 23B1 and surface layer 23B2 of the adjacent excess parts 23C are adherent to each other. The phenomenon that the surfaces adhere to each other in this manner is adhesion by mechanical bonding. This is a phenomenon widely known as an anchor effect or an anchoring effect.

In addition, when the swelling ratios of the resins of the surface layer 23B1 and surface layer 23B2 are excessively increased, the resins included in the surface layer 23B1 and surface layer 23B2 of the excess parts 23C are close to sol states from the gel states. In such a case, an anchor effect fails to be achieved, and thus, adhesion by mechanical bonding is not obtained.

In addition, the pores of the surface layer 23B1 and surface layer 23B2 have a function as a passage path for ions at the time of charging and discharging the lithium ion battery. In particular, when the swelling ratios of the resins of the surface layer 23B1 and surface layer 23B2 are excessively high, the battery temperature increased in the case of repeating large-current discharge softens the resins of the surface layer 23B1 and surface layer 23B2, thereby blocking pores. In such a condition, the ion permeability is insufficient, and thus, the characteristics of the battery are significantly degraded.

In a second embodiment, an electronic device including the battery according to the first embodiment will be described in further detail below.

FIG. 5 shows an example of the configuration of an electronic device 400 according to the second embodiment. The electronic device 400 includes an electronic circuit 401 of an electronic device body, and a battery pack 300. The battery pack 300 is electrically connected to the electronic circuit 401 with a positive electrode terminal 331a and a negative electrode terminal 331b interposed therebetween. The electronic device 400 may have a configuration in which the battery pack 300 is detachable.

Examples of the electronic device 400 include laptop personal computers, tablet computers, mobile phones (for example, smartphones), personal digital assistants (PDA), display devices (Liquid Crystal Display (LCD), Electro Luminescence (EL) display, electronic paper and the like), imaging devices (for example, digital still cameras, digital video cameras and the like), audio devices (for example, portable audio players), game consoles, cordless phones, e-books, electronic dictionaries, radios, headphones, navigation systems, memory cards, pacemakers, hearing aids, electric power tools, electric shavers, refrigerators, air conditioners, TVs, stereos, water heaters, microwave ovens, dishwashers, washing machines, dryers, lighting equipment, toys, medical equipment, and robots, but the electronic device 400 is not limited thereto.

The electronic circuit 401 includes, for example, a central processing unit (CPU), a peripheral logic unit, an interface unit, and a storage unit, and controls the overall electronic device 400.

The battery pack 300 includes an assembled battery 301 and a charge-discharge circuit 302. The battery pack 300 may further include an exterior material (not shown) that houses the assembled battery 301 and the charge-discharge circuit 302, if necessary.

The assembled battery 301 is composed of a plurality of secondary batteries 301a connected in series and/or in parallel. The plurality of secondary batteries 301a are connected, for example, in n parallel and m series (n and m are positive integers). Further, FIG. 5 shows an example in which six secondary batteries 301a are connected in 2 parallel and 3 series (2P3S). As the secondary battery 301a, the battery according to the first embodiment is used.

While case in which the battery pack 300 includes the assembled battery 301 composed of the plurality of secondary batteries 301a will be described, a configuration in which the battery pack 300 includes one secondary battery 301a instead of the assembled battery 301 may be employed.

The charge-discharge circuit 302 is a control unit that controls charging and discharging the assembled battery 301. Specifically, at the time of charging, the charge-discharge circuit 302 controls charging the assembled battery 301. In contrast, at the time of discharging (that is, during the use of the electronic device 400), the charge-discharge circuit 302 controls discharging the electronic device 400.

A case made of, for example, a metal, a polymer resin, or a composite material thereof can be used as the exterior material. Examples of the composite material include a laminate that has a metal layer and a polymer resin layer laminated.

### EXAMPLES

Hereinafter, the present application will be described according to an embodiment including with reference to examples, but the present application is not to be considered limited to the examples.

In the following examples and comparative examples, the ratio by mass R1, the ratio by mass R2, and the ratio (L/T) have values obtained by the measurement method described in the first embodiment.

### Examples 1-1 to 1-4, Comparative Examples 1-1 and 1-2

### (Step of Preparing Positive Electrode)

A positive electrode was prepared as follows. First, a lithium-containing composite oxide represented by LiNi_{0.80}Co_{0.15}Al_{0.05}O₂ was prepared as a positive electrode active material, carbon black was prepared as a conductive aid, and a polyvinylidene fluoride (PVDF) was prepared as a binder. Next, 2.5 parts by mass of the conductive aid was added to and mixed with 95.5 parts by mass of the positive electrode active material to obtain a mixture. Subsequently, a solution in which 1.9 parts by mass of the binder was dissolved in an organic solvent (N-methyl-2-pyrrolidone:NMP) was added to the mixture, and mixed to prepare a positive electrode mixture slurry, and then the positive electrode mixture slurry was allowed to pass through a 70-mesh net to remove a lithium-containing composite oxide that was large in particle size.

Next, the positive electrode mixture slurry was uniformly applied to both surfaces of a positive electrode current collector made of an aluminum foil of 10 μm in thickness and dried to form a positive electrode active material layer, and then, the positive electrode active material layer was subjected to compression molding with a roll press machine to prepare a positive electrode of 100 μm in total thickness. Next, the positive electrode was cut (slit) to prepare a rectangular positive electrode (see FIG. 1) with a square-shaped terminal part (current collector exposed part) protruded from one short side. In this regard, the size of the rectangular positive electrode was set to be 95 mm in length (long side) and 90 mm in width (short side), and the size of the square terminal part was set to be 20 mm in length and 20 mm in width.

### (Step of Preparing Negative Electrode)

A negative electrode was prepared as follows. First, graphite was prepared as a negative electrode active material, a styrene butadiene rubber (SBR) was prepared as a binder, and carboxymethyl cellulose (CMC) was prepared as a thickener. Next, the negative electrode active material, the binder, and the thickener were mixed at 98:1:1 in ratio by mass (negative electrode active material binder thickener), and water was further added to and mixed with the mixture to obtain a negative electrode mixture slurry.

Next, the negative electrode mixture slurry was uniformly applied to both surfaces of a negative electrode current collector made of a copper foil of 10 μm in thickness and dried to form a negative electrode active material layer, and then, the negative electrode active material layer was subjected to compression molding with a roll press machine to prepare a negative electrode of 100 μm in total thickness. Next, the negative electrode was cut (slit) to prepare a rectangular negative electrode (see FIG. 1) with a square-shaped terminal part (current collector exposed part) protruded from one short side. In this regard, the size of the rectangular negative electrode was set to be 100 mm in length (long side) and 95 mm in width (short side), and the size of the square terminal part was set to be 20 mm in length and 20 mm in width.

### (Step of Preparing Separator)

A separator was prepared as follows. First, a polyethylene resin and liquid paraffin as a plasticizer were supplied to a twin-screw extruder, and melted and kneaded to prepare a polyethylene solution. Next, the polyethylene solution was supplied to a hopper of the extruder, and the polyethylene solution was extruded at a predetermined temperature from a T-die attached to the tip of the extruder to form a gel-like sheet while winding the sheet with a cooling roll. Next, the gel-like sheet was biaxially stretched to obtain a thin film. Next, the thin film was washed with hexane to extract and remove the residual liquid paraffin, and then dried and heat-treated to make the thin film microporous, thereby preparing a polyethylene microporous film as a substrate.

Next, an aluminum oxide (Al₂O₃) (SUMICORUNDOM AA-03 from SUMITOMO CHEMICAL COMPANY, LIMITED) was prepared as inorganic particles, and a first modified polyvinylidene fluoride (Kureha KF Polymer W #9300 from KUREHA CORPORATION) and a second modified polyvinylidene fluoride (Kureha KF Polymer W #8200 from KUREHA CORPORATION) were prepared as resin materials. Next, the first modified polyvinylidene fluoride (W #9300) and the second modified polyvinylidene fluoride (W #8200) were blended at 3:7 in ratio by mass (W #9300:W #8200). Thus, the ratio by mass R1 (=(M2/M)×100) of the amount M2 of the hexafluoropropylene unit to the total amount M (=M1+M2) of the amount M1 of the vinylidene fluoride unit and the amount M2 of the hexafluoropropylene unit was set to be 5.8% in the surface layer included in the separator of the finished battery. It is to be noted that the first modified polyvinylidene fluoride (W #9300) and the second modified polyvinylidene fluoride (W #8200) are modified polyvinylidene fluoride modified with hexafluoropropylene. The amount M2 of the hexafluoropropylene unit of the second modified polyvinylidene fluoride (W #8200) is larger than the amount M2 of the hexafluoropropylene unit of the first modified polyvinylidene fluoride (W #9300). Next, the inorganic particles and the resin material blended as mentioned above were mixed to be 3:7 in ratio by mass (inorganic particles:resin material), and dispersed in an organic solvent (N-methyl-2-pyrrolidone:NMP) to prepare a resin solution.

Next, this resin solution was applied to both surfaces of the polyethylene microporous film with a gravure coater, put in a water bath to cause phase separation, and then dried with hot air. Thus, a separator was prepared in which a surface layer containing the aluminum oxide (Al₂O₃) and the polyvinylidene fluoride (PVdF) and including a porous structure was provided on both surfaces of the substrate made of the polyethylene microporous film. Thereafter, the separator was cut (slit) to prepare a rectangular separator of 101.6 mm in length (long side) and 96.6 mm in width (short side).

### (Step of Preparing Electrolytic Solution)

An electrolytic solution was prepared as follows. First, an ethylene carbonate (EC) as a first cyclic carbonate ester and a propylene carbonate (PC) as a second cyclic carbonate ester were mixed at 1:2 in ratio by mass (EC:PC) to prepare a mixed solvent of the cyclic carbonate esters. Next, the mixed solvent of the cyclic carbonate esters and a propyl propionate as a chain ester were mixed to prepare a mixed solvent. In this regard, the mixing ratio between the mixed solvent (cyclic carbonate esters) and the propyl propionate (chain ester) is adjusted, thereby setting the ratio by mass R2 (propyl propionate/mixed solvent) of the propyl propionate (chain ester) to the mixed solvent (cyclic carbonate esters) in the electrolytic solution of the finished battery to be 0.1, 0.2, 0.3, 0.5, 0.7, and 0.8 as shown in Table 1. Next, LiPF₆ was added to the mixed solvent so as to reach a concentration of 15% by mass, and then, a vinylene carbonate (VC) was added to the mixed solvent such that the content of the vinylene carbonate based on the total mass of the finally obtained electrolytic solution was 1.0% by mass, thereby preparing a non-aqueous electrolytic solution.

### (Step of Fabricating Laminate Type Battery)

A laminate-type battery was fabricated as follows. First, twenty positive electrodes, twenty one negative electrodes, and forty separators prepared as mentioned above were repeatedly stacked in the order of separator, negative electrode, separator, and positive electrode. In this regard, the orientations of the negative electrodes and positive electrodes were adjusted such that: the terminal parts of the positive electrodes and the terminal parts of the negative electrodes were protruded from the same end surface of the stacked body; the terminal parts of the positive electrodes were overlapped with each other; and the terminal parts of the negative electrodes were overlapped with each other. In addition, the position of stacking the separator with respect to the negative electrode was adjusted such that: the same amount of the separator was protruded from each of the four sides of the negative electrode to constitute a surplus part; and the ratio (L/T) of the length L of the excess part (protruded part) to the thickness T of the negative electrode (or the thickness of the positive electrode) was 8.

Next, the overlapped terminal parts of the positive electrodes were ultrasonically welded to each other, and the overlapped terminal parts of the negative electrodes were ultrasonically welded to each other. Next, a nickel tab was ultrasonically welded onto the welded terminal parts of the positive electrodes, and a nickel tab was ultrasonically welded onto the terminal parts of the negative electrodes to prepare a stacked electrode body. Thereafter, the electrode body was loaded between exterior materials, and three sides of the exterior materials were subjected to thermal fusion bonding, whereas the other one side thereof was not subjected to thermal fusion bonding, so as to have an opening. As the exterior material, a moisture-proof aluminum laminate film of a polyethylene terephthalate film, an aluminum foil, and a polypropylene film laminated in this order from the outermost layer was used.

Next, the electrolytic solution was injected through the opening of the exterior material, the remaining one side of the exterior material was subjected to thermal fusion bonding under reduced pressure to make the stacked electrode body hermetically sealed, and then, the electrode body was impregnated with the electrolytic solution by leaving to stand for 24 hours. Thereafter, for the stacked strength of the electrode body, the electrode body was sandwiched from above and below with metal plates heated to 70° C., and pressurized at 5 MPa for 5 minutes. Thus, a laminate-type battery was fabricated.

### Examples 2-1 to 2-4, Comparative Examples 2-1 and 2-2

As shown in Table 1, the first modified polyvinylidene fluoride (W #9300) and the second modified polyvinylidene fluoride (W #8200) were blended at 5:5 in ratio by mass (W #9300:W #8200) in the step of preparing the separator. Thus, the ratio by mass R1 in the surface layer included in the separator of the finished battery was set to be 5.0%. In the same manner as in Examples 1-1 to 1-4 and Comparative Examples 1-1 and 1-2 except for the foregoing, laminate-type batteries were fabricated.

### Examples 3-1 to 3-4, Comparative Examples 3-1 and 3-2

As shown in Table 1, the first modified polyvinylidene fluoride (W #9300) and the second modified polyvinylidene fluoride (W #8200) were blended at 6.5:3.5 in ratio by mass (W #9300:W #8200) in the step of preparing the separator. Thus, the ratio by mass R1 in the surface layer included in the separator of the finished battery was set to be 4,4%. In the same manner as in Examples 1-1 to 1-4 and Comparative Examples 1-1 and 1-2 except for the foregoing, laminate-type batteries were fabricated.

### Examples 4-1 to 4-4, Comparative Examples 4-1 and 4-2

As shown in Table 1, the first modified polyvinylidene fluoride (W #9300) and the second modified polyvinylidene fluoride (W #8200) were blended at 7:3 in ratio by mass (W #9300:W #8200) in the step of preparing the separator. Thus, the ratio by mass R1 in the surface layer included in the separator of the finished battery was set to be 4.2%. In the same manner as in Examples 1-1 to 1-4 and Comparative Examples 1-1 and 1-2 except for the foregoing, laminate-type batteries were fabricated.

### Comparative Examples 5-1 to 5-6

As shown in Table 1, the first modified polyvinylidene fluoride (W #9300) and the second modified polyvinylidene fluoride (W #8200) were blended at 2:8 in ratio by mass (W #9300:W #8200) in the step of preparing the separator. Thus, the ratio by mass R1 in the surface layer included in the separator of the finished battery was set to be 6.2%. In the same manner as in Examples 1-1 to 1-4 and Comparative Examples 1-1 and 1-2 except for the foregoing, laminate-type batteries were fabricated.

### Comparative Examples 6-1 to 6-6

As shown in Table 1, the first modified polyvinylidene fluoride (W #9300) and the second modified polyvinylidene fluoride (W #8200) were blended at 8:2 in ratio by mass (W #9300:W #8200) in the step of preparing the separator. Thus, the ratio by mass R1 in the surface layer included in the separator of the finished battery was set to be 3.8%. In the same manner as in Examples 1-1 to 1-4 and Comparative Examples 1-1 and 1-2 except for the foregoing, laminate-type batteries were fabricated.

### Comparative Example 7-1

As shown in Table 1, in the step of preparing the electrolytic solution, the mixing ratio between the mixed solvent (cyclic carbonate esters) and the propyl propionate (chain ester) is adjusted, thereby setting the ratio by mass R2 (propyl propionate/mixed solvent) of the propyl propionate (chain ester) to the mixed solvent (cyclic carbonate esters) in the electrolytic solution of the finished battery to be 0.4.

In addition, after stacking the positive electrodes, the negative electrodes, and the separators in the step of fabricating the laminate-type battery, the stacked body was pressurized with a heat block heated to 120° C. to cause excess parts at the four sides of the separators to adhere to each other, thereby forming bag-shaped separators wrapping each of the positive electrodes and negative electrodes.

In the same manner as in Example 2-1 except for the foregoing, a laminate-type battery was fabricated.

### Examples 8-1 and 8-2

Laminate-type batteries were fabricated in the same manner as in Example 3-2 except for adjusting the cutting size of the negative electrode in the step of preparing the negative electrode and adjusting the cutting size of the separator in the step of preparing the separator such that the ratio (L/T) of the length L of the excess part of the separator and the thickness T of the negative electrode (or the thickness of the positive electrode) was 4 or 7 as shown in Table 1.

### [Evaluation]

The laminate-type batteries obtained in the manners mentioned above were evaluated as follows.

### (Evaluation of Adhesion Strength)

The adhesion strength Ts between the excess parts of the separators was determined as follows. First, the laminate-type battery was disassembled, the two separators sandwiching the positive electrode or the negative electrode were taken out, and an electrolytic solution was extracted. Next, from each of the two separators taken out, a separator piece was cut out in a rectangular shape in the same size. Next, after two separator pieces were stacked to prepare a test piece, 0.5 ml of the extracted electrolytic solution was uniformly delivered by drops onto the test piece, and the test piece was vacuum-sealed with an aluminum laminate film, and left to stand for 24 hours to impregnate the test piece with the electrolytic solution, thereby preparing a test sample.

Next, the test sample was put in a thermostatic chamber set at 85° C., and then heated for 10 minutes such that the surface temperature of the sample was 85° C.±2° C. Next, the ends in the longitudinal direction of the test sample were peeled, the peeled ends were fixed respectively to jigs disposed to face each other in an autograph (AG-IS from SHIMADZU CORPORATION), and a 180° peel test was performed with the use of the autograph to acquire a graph showing the relationship between the test force [N] and the stroke [mm]. It is to be noted that the 180° peel test was performed at a test speed of 100 mm/min under an environment at an environmental temperature of 23±3° C. and a humidity of 40 to 70% RH.

When the adhesion strength Ts meets Ts≥4.00, the voltage E [V] immediately after the end of the 130° C. heating test described later can be controlled to be 0 V<E, and the safety of the battery can be thus improved.

Next, the whole peeling length peeled by the 180° peeling test was determined to be 100%, and after the start of the measurement, the strength obtained at the length of 26% to 80% from the start of peeling between the separators was averaged to calculate the average value. Next, the average value was divided by the width of the test piece to obtain the adhesion strength of the test piece, and the adhesion strength of the test piece was defined as the adhesion strength Ts (N/m) of the excess part.

### (Evaluation of Safety)

### <Evaluation of Safety by 130° C. Heating Test>

The battery was subjected to the 130° C. heating test, the voltage E [V] immediately after the end of the test was measured, and based on the measured voltage, the safety of the battery was evaluated on the following scale of three levels: [symbol] ; ◯; and x.

[symbol] means that the voltage E [V] immediately after the end of the 130° C. heating test is 3.5 V≤E.

◯ means that the voltage E [V] immediately after the end of the 130° C. heating test meets 0 V<E<3.5 V.

x means that the voltage E [V] immediately after the end of the 130° C. heating test meets is E=0 V.

Further, when the voltage E [V] immediately after the end of the 130° C. heating test meets 0 V<E, the safety can be improved. The safety can be enhanced with the increased voltage E [V] immediately after the end of the 130° C. heating test, and from the viewpoint of improving the safety, the voltage E [V] immediately after the end of the 130° C. heating test preferably meets 3.5 V≤E.

Details of the 130° C. heating test are as follows. First, the battery was fully charged, and the temperature of the battery was stabilized at 20±5° C. Next, the battery was housed in a thermostatic chamber, and the temperature of the thermostatic chamber was raised to 130±2° C. at a temperature rising rate of 5±2° C. for 1 minute. Thereafter, the temperature of the thermostatic chamber was maintained at 130±2° C. for 60 minutes, and the test was terminated after 60 minutes.

### <Evaluation of Safety by 135° C. Heating Test>

The battery was subjected to a 135° C. heating test (limit test), the voltage E [V] immediately after the end of the test was measured, and based on the measured voltage, the safety of the battery was evaluated on the same scale of three levels: [symbol] ; ◯; and x as in the 130° C. heating test mentioned above.

Further, from the viewpoint of improving the safety, the voltage E [V] immediately after the end of the 135° C. heating test preferably meets 0 V<E, more preferably 3.5 V≤E.

Details of the 135° C. heating test are as follows. The test was performed in the same manner as in the 130° C. heating test except for raising the temperature of the thermostatic chamber to 135° C.±2° C. at a temperature rising rate of 5±2° C. for 1 minute, and then holding the temperature of the thermostatic bath at 135° C.±2° C. for 60 minutes.

### (Evaluation of Load Characteristics)

First, the battery was repeatedly charged and discharged 10 times at an environmental temperature of 25° C. under the following conditions:

Charge (CCCV charge): Constant Current (CC) charge with 1 C-4.2 V Cut-off, Constant Voltage (CV) charge with 4.2 V-0.001 C Cut-off

Discharge (CC discharge): 5 C discharge, 2.5 V Cut-off or 80° C. Cut-off

Next, the discharge capacity retention rate was determined from the following equation.

Discharge capacity retention rate [%]=((discharge capacity of last cycle)/(discharge capacity of first cycle))×100

Next, based on the discharge capacity retention rate in the manner mentioned above, the load characteristics were evaluated on a scale of three levels: [symbol] ; ◯; and x.

[symbol] means that the discharge capacity retention rate is 85% or more.

◯ means that the discharge capacity retention rate is 80% or more and less than 85%.

x means that the discharge capacity retention rate is less than 80%

(Evaluation of Productivity)

First, the battery was disassembled to check whether or not a site of the whole separator was not wet with the electrolytic solution. Whether the separator was wet with the electrolytic solution or not was determined by the color of the separator. Two regions of: a region with higher transparency and a region with lower transparency were visually discriminated from each other, and the region with higher transparency was discriminated as a wet site. Next, based on the results of the check mentioned above, the productivity was evaluated.

◯ means that the whole separator is wet with the electrolytic solution, with the favorable impregnation property of the electrolytic solution, thus causing no decrease in the productivity of the battery.

x means that a site of the whole separator is not wet with the electrolytic solution, with the poor impregnation property of the electrolytic solution, thus decreasing the productivity of the battery.

### [Evaluation Results]

TABLE 1

| | | Ratio | | | | | | | |
|---|---|---|---|---|---|---|---|---|---|
| | Blending | by | | | | | | | |
| | Ratio of | Mass | Ratio by | | | | | | |
| | PVdF | R1 of | Mass R2 | | Adhesion | | | | |
| | (W | HFP | (Cyclic | | Strength | | 130° C. | 135° C. | |
| | #9300:W | Unit | Solvent/Chain | | Ts | Load | Heating | Heating | |
| | #8200) | [%] | Solvent) | L/T | [mN/mm] | Characteristics | Test | Test | Productivity |
| Comparative | 2:8 | 6.2 | 0.8 | 8 | 2.30 | X | X | X | ◯ |
| Example 5-1 | | | | | | | | | |
| Comparative | 2:8 | 6.2 | 0.7 | 8 | 7.21 | X | ⊚ | ◯ | ◯ |
| Example 5-2 | | | | | | | | | |
| Comparative | 2:8 | 6.2 | 0.5 | 8 | 20.30 | X | ⊚ | ◯ | ◯ |
| Example 5-3 | | | | | | | | | |
| Comparative | 2:8 | 6.2 | 0.3 | 8 | 21.00 | X | ⊚ | ◯ | ◯ |
| Example 5-4 | | | | | | | | | |
| Comparative | 2:8 | 6.2 | 0.2 | 8 | 22.50 | X | ⊚ | ◯ | ◯ |
| Example 5-5 | | | | | | | | | |
| Comparative | 2:8 | 6.2 | 0.1 | 8 | 22.30 | X | ⊚ | ◯ | ◯ |
| Example 5-6 | | | | | | | | | |
| Comparative | 3:7 | 5.8 | 0.8 | 8 | 0.09 | ◯ | X | X | ◯ |
| Example 1-1 | | | | | | | | | |
| Example 1-1 | 3:7 | 5.8 | 0.7 | 8 | 5.23 | ◯ | ⊚ | ◯ | ◯ |
| Example 1-2 | 3:7 | 5.8 | 0.5 | 8 | 14.98 | ◯ | ⊚ | ◯ | ◯ |
| Example 1-3 | 3:7 | 5.8 | 0.3 | 8 | 15.50 | ◯ | ⊚ | ◯ | ◯ |
| Example 1-4 | 3:7 | 5.8 | 0.2 | 8 | 16.21 | ◯ | ⊚ | ◯ | ◯ |
| Comparative | 3:7 | 5.8 | 0.1 | 8 | 17.01 | X | ⊚ | ◯ | ◯ |
| Example 1-2 | | | | | | | | | |
| Comparative | 5:5 | 5.0 | 0.8 | 8 | 0.09 | ◯ | X | X | ◯ |
| Example 2-1 | | | | | | | | | |
| Example 2-1 | 5:5 | 5.0 | 0.7 | 8 | 5.23 | ⊚ | ⊚ | X | ◯ |
| Example 2-2 | 5:5 | 5.0 | 0.5 | 8 | 14.98 | ⊚ | ⊚ | ◯ | ◯ |
| Example 2-3 | 5:5 | 5.0 | 0.3 | 8 | 15.50 | ⊚ | ⊚ | ◯ | ◯ |
| Example 2-4 | 5:5 | 5.0 | 0.2 | 8 | 16.21 | O | ⊚ | ◯ | ◯ |
| Comparative | 5:5 | 5.0 | 0.1 | 8 | 17.01 | X | ⊚ | X | ◯ |
| Example 2-2 | | | | | | | | | |
| Comparative | 6.5:3.5 | 4.4 | 0.8 | 8 | 0 | ◯ | X | X | ◯ |
| Example 3-1 | | | | | | | | | |
| Example 3-1 | 6.5:3.5 | 4.4 | 0.7 | 8 | 4.68 | ⊚ | ⊚ | X | ◯ |
| Example 3-2 | 6.5:3.5 | 4.4 | 0.5 | 8 | 5.13 | ⊚ | ⊚ | ◯ | ◯ |
| Example 3-3 | 6.5:3.5 | 4.4 | 0.3 | 8 | 5.21 | ⊚ | ⊚ | ◯ | ◯ |
| Example 3-4 | 6.5:3.5 | 4.4 | 0.2 | 8 | 5.45 | ◯ | ⊚ | ◯ | ◯ |
| Comparative | 6.5:3.5 | 4.4 | 0.1 | 8 | 6.24 | X | ⊚ | X | ◯ |
| Example 3-2 | | | | | | | | | |
| Comparative | 7:3 | 4.2 | 0.8 | 8 | 0 | ◯ | X | X | ◯ |
| Example 4-1 | | | | | | | | | |
| Example 4-1 | 7:3 | 4.2 | 0.7 | 8 | 4.02 | ⊚ | ⊚ | X | ◯ |
| Example 4-2 | 7:3 | 4.2 | 0.5 | 8 | 4.10 | ⊚ | ⊚ | X | ◯ |
| Example 4-3 | 7:3 | 4.2 | 0.3 | 8 | 4.23 | ⊚ | ⊚ | X | ◯ |
| Example 4-4 | 7:3 | 4.2 | 0.2 | 8 | 4.46 | ◯ | ⊚ | X | ◯ |
| Comparative | 7:3 | 4.2 | 0.1 | 8 | 4.81 | X | ⊚ | X | ◯ |
| Example 4-2 | | | | | | | | | |
| Comparative | 8:2 | 3.8 | 0.8 | 8 | 0 | ◯ | X | X | ◯ |
| Example 6-1 | | | | | | | | | |
| Comparative | 8:2 | 3.8 | 0.7 | 8 | 2.80 | ⊚ | X | X | ◯ |
| Example 6-2 | | | | | | | | | |
| Comparative | 8:2 | 3.8 | 0.5 | 8 | 3.20 | ⊚ | X | X | ◯ |
| Example 6-3 | | | | | | | | | |
| Comparative | 8:2 | 3.8 | 0.3 | 8 | 3.62 | ⊚ | X | X | ◯ |
| Example 6-4 | | | | | | | | | |
| Comparative | 8:2 | 3.8 | 0.2 | 8 | 3.71 | ◯ | X | X | ◯ |
| Example 6-5 | | | | | | | | | |
| Comparative | 8:2 | 3.8 | 0.1 | 8 | 4.01 | X | ⊚ | X | ◯ |
| Example 6-6 | | | | | | | | | |
| Comparative | 5:5 | 5.0 | 0.4 | 8 | >30 | ◯ | ⊚ | X | X |
| Example 7-1 | | | | | | | | | |
| Example 8-1 | 6.5:3.5 | 4.4 | 0.5 | 4 | 5.13 | ⊚ | ◯ | X | ◯ |
| Example 8-2 | 6.5:3.5 | 4.4 | 0.5 | 7 | 5.13 | ⊚ | ◯ | X | ◯ |

### (Evaluation of Adhesion Strength)

It is confirmed that as the ratio by mass R1 of the hexafluoropropylene unit in the surface layer of the separator is increased, the adhesion strength Ts between the excess parts of the separator is increased.

If the same separator is used, it is confirmed that the adhesion strength Ts between the excess parts of the separator is increased as the content of the chain carbonate in the electrolytic solution is increased, that is, as the ratio by mass R2 is decreased.

### (Evaluation Results of Safety)

In the case of the batteries obtained with the use of the separator with the low ratio by mass R1 of hexafluoropropylene unit in the surface layer: R1=3.8%, it is confirmed that it is difficult to improve the battery safety, except for the battery with the high content of the chain carbonate in the electrolytic solution and the ratio by mass R2:R2=0.1.

In the case of the batteries obtained with the low content of the chain carbonate in the electrolytic solution and the ratio by mass R2:R2=0.8, it is confirmed that it is difficult to improve the battery safety, except for the battery with the high ratio by mass R1 of the hexafluoropropylene units in the surface layer: R1=6.2%.

In the case of the batteries obtained with the high ratio by mass R1 of the hexafluoropropylene unit in the surface layer: R1=6.2%, the improved battery safety is confirmed, regardless of the content of the chain carbonate in the electrolytic solution.

In the case of the battery with the bag-shaped separator used (Comparative Example 7-1), the improved load characteristics and safety are confirmed. The impregnation property of the electrolytic solution is, however, decreased in the step of fabricating the laminate-type battery, and thus, the decreased productivity is confirmed. In addition, the productivity is decreased also from the viewpoint of causing the need to add a step of causing the excess parts of the separators to adhere to each other in the step of fabricating the laminate-type battery.

In the case of the batteries with the excess parts of the separators reduced in length and the ratio (L/T) of the length L of the excess part of the separator to the thickness T of the negative electrode (or the thickness of the positive electrode) set to be 4 or 7 (Examples 8-1, 8-2), the improved battery safety is confirmed.

### (Evaluation of Load Characteristics)

In the case of the batteries obtained with the use of the separator with the high ratio by mass R1 of the hexafluoropropylene unit in the surface layer: R1=6.2%, the load characteristics deteriorated are confirmed, regardless of the ratio by mass of the chain carbonate in the electrolytic solution.

In the case of the batteries with the high content of the chain carbonate in the electrolytic solution and the ratio by mass R2:R2=0.1, the load characteristics deteriorated are confirmed, regardless of the ratio by mass R1 of the hexafluoropropylene unit in the surface layer.

Although one or more embodiments of the present application have been described herein, the present application is not to be considered limited thereto, and various suitable modifications based on the technical aspects of the present application can be made.

For example, the configurations, methods, steps, shapes, materials, numerical values, and the like listed in the embodiments mentioned herein are considered by way of example only, and configurations, methods, steps, shapes, materials, numerical values, and the like that are different from the foregoing examples, may be used, if necessary.

The configurations, methods, steps, shapes, materials, and numerical values of the embodiments mentioned herein can be combined with each other without departing from the spirit of the present application.

In the numerical ranges described in stages in the embodiments mentioned above, the upper limit or lower limit of the numerical range in a certain stage may be replaced with the upper limit value or lower limit of the numerical range in another stage.

Unless otherwise specified, one of the materials exemplified in the embodiments mentioned herein may be used singly, or two or more thereof may be used in combination.

### DESCRIPTION OF REFERENCE SYMBOLS

10: Exterior material
11: Positive electrode lead
12: Negative electrode lead
13: Close contact film
20: Electrode body
21: Positive electrode
21A: Positive electrode current collector
21B1, 21B2: Positive electrode active material layer
21C: Terminal part
22: Negative electrode
22A: Negative electrode current collector
22B1, 22B2: Negative electrode active material layer
22C: Terminal part
23: Separator
23A: Substrate
23B1, 23B2: Surface layer
23C: Excess part
300: Battery pack
400: Electronic device

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A non-aqueous electrolyte secondary battery comprising an electrode body and a non-aqueous electrolytic solution,
wherein the electrode body comprises a plurality of positive electrodes, a plurality of negative electrodes, and a plurality of separators, and the positive electrodes and the negative electrodes are stacked such that the separators are sandwiched therebetween, and such that the separators are protruded from peripheral edges of the positive electrodes and of the negative electrode,
peripheral edges of the separators adjacent to each other with the positive electrode interposed therebetween have contact with each other, and peripheral edges of the separators adjacent to each other with the negative electrode interposed therebetween have contact with each other,
the separator comprises a substrate, a first surface layer provided on a first surface of the substrate, and a second surface layer provided on a second surface of the substrate,
the first surface layer and the second surface layer comprise a polymer comprising a vinylidene fluoride unit and a hexafluoropropylene unit,
a ratio by mass of an amount of the hexafluoropropylene unit to a total amount of an amount of the vinylidene fluoride unit and the amount of the hexafluoropropylene unit is 4.2% or more and 5.8% or less, and
the non-aqueous electrolytic solution comprises a cyclic carbonate ester and a chain ester, and a ratio by mass of the cyclic carbonate ester to the chain ester is 0.2 or more and 0.7 or less.

2. The non-aqueous electrolyte secondary battery according to claim 1, wherein when the peripheral edges of the separators adhere to each other after heating at a battery surface temperature of 85° C. for 10 minutes, adhesion strength between the peripheral edges of the separators is preferably 4.00 mN/mm or more.

3. The non-aqueous electrolyte secondary battery according to claim 1, wherein a ratio (L/T) of a length L of a protruded part of the separator to a thickness T of the thicker electrode of the positive electrode and the negative electrode is 4 or more, with the peripheral edge located on an outer side as a reference, of the peripheral edges of the positive electrode and of the negative electrode.

4. The non-aqueous electrolyte secondary battery according to claim 1, wherein the peripheral edges of the plurality of separators are bent in a same stacking direction.
